(19) United States
(12) Patent Application Publication
(10) Pub. No.: US 2026/0264799 A1
(43) Pub. Date: Sep. 10, 2026

(54) FRONT FORK

(71) Applicant: KYB Motorcycle Suspension Co.,Ltd., Gifu (JP)

(72) Inventor: Yuichi AMIKI, Gifu (JP)

(73) Assignee: KYB Motorcycle Suspension Co.,Ltd., Gifu (JP)

(21) Appl. No.: 18/876,197

(22) PCT Filed: Aug. 21, 2023
(86) PCT No.: PCT/JP2023/030030

§ 371 Date: Dec. 18, 2024

(30) Foreign Application Priority Data
Oct. 27, 2022 (JP) 2022-172640

(51) Int. Cl. B62K 25/08; B62K 25/04

(52) U.S. Cl. CPC B62K 25/08; B62K 2025/048

(57) ABSTRACT

In order to achieve the above object, a front fork includes an adjuster that is mounted to a cap that closes an upper end portion of a vehicle body side tube and is capable of adjusting a damping force variable valve. The adjuster includes a lever that is provided at an upper end of an adjuster main body that is mounted to the cap so as to be capable of rotating in a circumferential direction by being screwed and extends in a radial direction from the upper end of the adjuster main body. The cap includes a stopper that protrudes in an axial direction from an upper end of the cap main body that closes the upper end portion of the vehicle body side tube and restricts rotation of the lever when abutting on the lever, and an air valve that opens from an upper end of the stopper and is accommodated in an air hole that communicates with an inside of a fork main body.

### TECHNICAL FIELD

The present invention relates to a front fork.

### BACKGROUND ART

There is a front fork that supports front wheels of a straddle vehicle, and that is interposed between a vehicle body and a front wheel axle of the straddle vehicle to exert a damping force. Such a front fork is generally configured to include a fork main body that includes: a vehicle body side tube connected to the vehicle body of the straddle vehicle and an axle side tube fitted to the vehicle body side tube and connected to the front wheel axle, and expands and contracts; and a damper cartridge that is accommodated in the fork main body and that exerts a damping force accompanying expansion and contraction of the fork main body.

The front fork may be provided with an adjuster that adjusts a damping force characteristic so that the damping force characteristic can be changed to a characteristic desired by a user. For example, as disclosed in JP 2015-63998 A, a valve is provided in the middle of a communication passage that causes a reservoir formed between a fork main body and a damper cartridge and an inside of the damper cartridge to communicate with each other, and a valve opening pressure of the valve is adjusted by the adjuster (see, for example, Patent Literature 1).

Specifically, in the front fork disclosed in JP 2015-63998 A, a cap is provided with a through hole that opens from an upper end of the cap and causes the inside and outside of the front fork to communicate with each other. A columnar adjuster is screwed to an inner periphery of the through hole, and a coil spring that biases the valve in a closing direction is installed between a lower end of the adjuster and the valve. As a result, when the adjuster is rotationally operated and the adjuster moves in an axial direction, a distance between the adjuster and the valve increases and a biasing force of the coil spring changes, so that the valve opening pressure of the valve can be adjusted.

### CITATION LIST

### Patent Literature

Patent Literature 1: JP 2015-63998 A

### SUMMARY OF INVENTION

### Technical Problem

In the front fork disclosed in JP 2015-63998 A, the through hole includes a small-diameter hole portion to which the adjuster is screwed, and a large-diameter hole portion provided above the small-diameter hole portion and having a larger diameter than the small-diameter hole portion. A cylindrical adjuster case is press-fitted into an inner periphery of the large-diameter hole portion of the through hole.

The adjuster case has an annular flange portion protruding inward from an inner periphery of an upper end. On the other hand, the adjuster includes a small-diameter portion provided on the upper end side and inserted into the inner periphery of the flange portion, and a large-diameter portion connected to a lower end of the small-diameter portion and having an outer diameter larger than an inner diameter of the flange portion.

As a result, in the front fork disclosed in JP 2015-63998 A, since a lower end of the flange portion of the adjuster case and an upper end of the large-diameter portion of the adjuster face each other in the axial direction, the adjuster can be prevented from coming off the cap by the rotational operation.

However, as described above, since the adjuster case is press-fitted into the inner periphery of the through hole of the cap, a process of press-fitting the adjuster case into the inner periphery of the through hole is required at the time of assembling the front fork, and this press-fitting process causes an increase in an assembly cost of the front fork.

JP 2015-63998 A also discloses a method in which an annular groove is provided on the inner periphery of the upper end of the through hole of the cap, and a snap ring is fitted to the annular groove, thereby preventing the adjuster from coming off the cap by the rotational operation. However, in this case, it is necessary to perform a process of providing the annular groove on the inner periphery of the upper end of the through hole of the cap, which leads to an increase in a processing cost.

Therefore, an object of the present invention is to provide a front fork capable of preventing an adjuster from coming off a cap without press-fitting an adjuster case or installing a snap ring, and capable of reducing an assembly cost and a processing cost.

### Solution to Problem

In order to achieve the above object, a front fork of the present invention includes: an adjusted portion accommodated in a fork main body in which a vehicle body side tube and an axle side tube are slidably fitted; and an adjuster mounted to a cap that closes an upper end portion of the vehicle body side tube and capable of adjusting the adjusted portion, in which the adjuster includes an adjuster main body that is mounted to the cap so as to be capable of rotating in a circumferential direction by being screwed into the cap or the adjusted portion, and a lever that is provided at an upper end of the adjuster main body and extends in a radial direction from the upper end of the adjuster main body, and the cap includes a cap main body that closes the upper end portion of the vehicle body side tube, a stopper that protrudes in an axial direction from an upper end of the cap main body and restricts rotation of the lever when abutting on the lever, an air hole that opens from an upper end of the stopper and communicates with an inside of the fork main body, and an air valve accommodated in the air hole. According to this configuration, in a state where the adjuster main body is mounted to the cap by screwing, a rotatable range of the lever becomes less than one rotation by the stopper.

Therefore, when the adjuster main body is screwed into the cap or the adjusted portion by being screwed at least one rotation or more, the adjuster can be prevented from falling off the cap by the rotational operation of the lever by a user.

### BRIEF DESCRIPTION OF DRAWINGS

FIG. 1 is a longitudinal cross-sectional view of a front fork according to an embodiment of the present invention.

FIG. 2 is a partially enlarged longitudinal cross-sectional view of a damper cartridge accommodated in the front fork according to the embodiment of the present invention.

FIG. 3 is a partially enlarged cross-sectional view of an upper end side of the front fork according to the embodiment of the present invention.

FIG. 4 is a plan view of the front fork according to the embodiment of the present invention.

FIG. 5 is an exploded perspective view of a cap and an adjuster according to the embodiment of the present invention.

FIG. 6 is a perspective view of a lever according to the embodiment of the present invention as viewed from a bottom surface side.

FIG. 7 is an exploded longitudinal cross-sectional view of a modification of a lever and an adjuster main body according to the embodiment of the present invention.

### DESCRIPTION OF EMBODIMENTS

An embodiment of the present invention will be described below with reference to the drawings. The same reference signs throughout the several drawings indicate the same part.

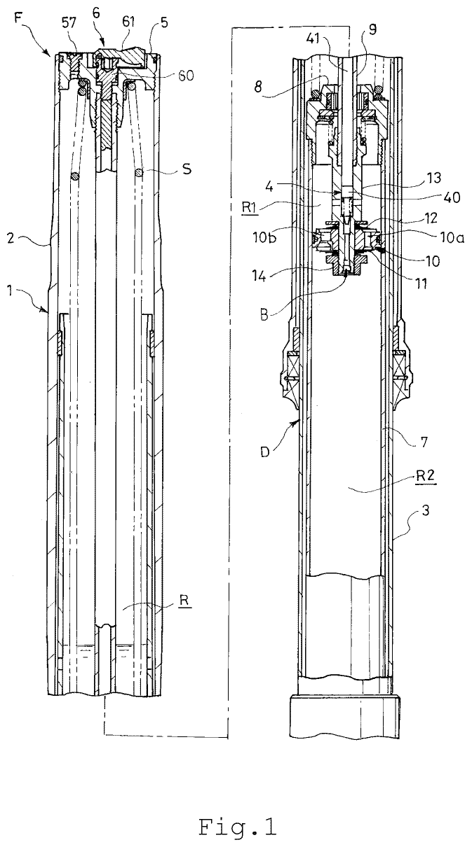

As illustrated in FIG. 1, a front fork F of the present embodiment includes a fork main body 1 in which a vehicle body side tube 2 and an axle side tube 3 are slidably fitted, a damping force variable valve 4 configuring a part of an adjusted portion accommodated in the fork main body 1, a cap 5 that closes an upper end portion of the vehicle body side tube 2, and an adjuster 6 that is mounted to the cap 5 and capable of adjusting a damping force characteristic of the damping force variable valve 4.

In the following description, the upper and lower sides in a state where the vehicle body side tube 2 is disposed on a vehicle body side of a straddle vehicle, the axle side tube 3 is disposed on an axle side of the straddle vehicle, and the front fork F is interposed between the vehicle body and an axle of the straddle vehicle are simply referred to as “upper” and “lower”.

Hereinafter, each unit of the front fork F of the present embodiment will be described in detail. As illustrated in FIG. 1, the fork main body 1 is configured by slidably inserting the axle side tube 3 having a diameter smaller than that of the vehicle body side tube 2 into the vehicle body side tube 2 via a bearing (not illustrated), and is expandable and contractible. The vehicle body side tube 2 may be set to have a smaller diameter than the axle side tube 3, and the vehicle body side tube 2 may be inserted into the axle side tube 3.

A damper cartridge D is accommodated in the fork main body 1, and the damper cartridge D expands and contracts as the fork main body 1 expands and contracts to exert a damping force. As illustrated in FIG. 1, a suspension spring S that biases the fork main body 1 in an extending direction is interposed between the cap 5 that closes the upper end portion of the vehicle body side tube 2 and an upper end of the damper cartridge D.

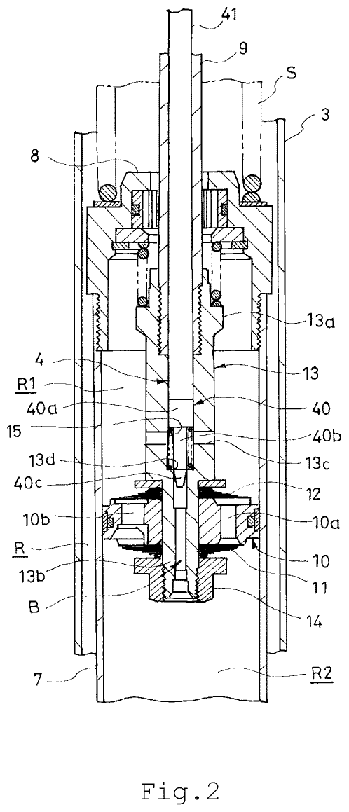

As illustrated in FIGS. 1 and 2, the damper cartridge D includes a cylinder 7 fixed to a bottom cap (not illustrated) that closes a lower end opening edge of the axle side tube 3, an annular rod guide 8 mounted to an upper end opening edge of the cylinder 7, a cylindrical piston rod 9 that is inserted into an inner periphery of the rod guide 8, is movably inserted into the cylinder 7, and has an upper end connected to the cap 5 that closes the upper end opening edge of the vehicle body side tube 2, and a piston 10 that is connected to the piston rod 9, is slidably inserted into the cylinder 7, and partitions an inside of the cylinder 7 into an extension side chamber R1 and a compression side chamber R2 filled with a liquid.

Furthermore, an annular gap formed between the damper cartridge D and the fork main body 1 is used as a reservoir R filled with a liquid and a gas, and the reservoir R communicates with the compression side chamber R2 through holes (not illustrated) provided in the cylinder 7. Therefore, a liquid corresponding to a volume of the piston rod 9 entering and exiting the cylinder 7 at the time of expansion and contraction is exchanged between the inside of the cylinder 7 and the reservoir R, so that volume compensation can be performed. Although hydraulic oil is used as the liquid in the present embodiment, the liquid used for the front fork F may be, for example, water or a liquid such as an aqueous solution in addition to the hydraulic oil.

Furthermore, the piston 10 includes an extension side port 10a and a compression side port 10b that have an annular shape, and cause the extension side chamber R1 and the compression side chamber R2 to communicate with each other. Furthermore, an annular extension side leaf valve 11 that opens and closes the extension side port 10a is laminated at the lower end of the piston 10 in FIG. 1, and an annular compression side leaf valve 12 that opens and closes the compression side port 10b is laminated at the upper end of the piston 10 in FIG. 2.

These piston 10, extension side leaf valve 11, and compression side leaf valve 12 are mounted together to an outer periphery of a piston connecting member 13 connected to the lower end of the piston rod 9 in FIG. 2.

As illustrated in FIG. 2, the piston connecting member 13 of the present embodiment is cylindrical and includes a cylindrical socket portion 13a that is screwed to the outer periphery of the lower end of the piston rod 9, and a cylindrical piston mounting shaft 13b that has an outer diameter smaller than that of the socket portion 13a and extends downward from the socket portion 13a in the drawing.

As illustrated in FIG. 2, in a state where the compression side leaf valve 12, the piston 10, and the extension side leaf valve 11 are mounted to the outer periphery of the piston mounting shaft 13b of the piston connecting member 13 in this order from the top, a piston nut 14 is screwed onto the outer periphery of the lower end of the piston mounting shaft 13b. As a result, the compression side leaf valve 12, the piston 10, and the extension side leaf valve 11 are sandwiched between a stepped portion formed between the socket portion 13a and the piston mounting shaft 13b and the piston nut 14, and are fixed to the outer periphery of the piston mounting shaft 13b.

At this time, the inner peripheral sides of the extension side leaf valve 11 and the compression side leaf valve 12 are fixed to the piston mounting shaft 13b, and the outer peripheral sides thereof are bent to be separated from the piston 10, so that the corresponding extension side port 10a and compression side port 10b can be opened.

Further, the piston connecting member 13 of the present embodiment includes a horizontal hole 13c that opens from the side facing the extension side chamber R1 of the socket portion 13a and communicates with the inside, and an annular valve seat 13d provided with an inner diameter smaller than that of the horizontal hole 13c.

Although the annular valve seat 13d is formed by forming a stepped portion by providing a portion where an inner diameter is reduced, a cylindrical or annular member may be mounted into the piston connecting member 13, and the annular valve seat may be provided by this member.

The lower end of the piston connecting member 13 faces the compression side chamber R2, the horizontal hole 13c faces the extension side chamber R1, and the horizontal hole 13c and a portion inside the piston connecting member 13 and closer to the compression side chamber R2 than the horizontal hole 13c form a bypass passage B that bypasses the extension side port 10a and the compression side port 10b and causes the extension side chamber R1 and the compression side chamber R2 to communicate with each other.

The front fork F of the present embodiment includes the damping force variable valve 4 capable of adjusting a flow path area of the bypass passage B. The damping force variable valve 4 is a needle valve. As illustrated in FIGS. 1 and 2, the damping force variable valve 4 includes the annular valve seat 13d, and a needle 40 that is accommodated so as to be movable in the axial direction in the piston connecting member 13 and is seated on and separated from the annular valve seat 13d. The flow path area of the bypass passage B can be changed by up and down movement of an adjustment rod 41 that is slidably inserted into the inner periphery of the piston rod 9 and has a lower end abutting on an upper end of the needle 40. The needle 40 may be integrally connected to a lower end of the adjustment rod 41.

As illustrated in FIG. 2, the needle 40 has a columnar base portion 40a slidably inserted into the inner periphery of the piston connecting member 13, a shaft portion 40b having an outer diameter smaller than that of the base portion 40a and extending from a lower end of the base portion 40a, and a conical valve head 40c provided at a lower end of the shaft portion 40b and capable of being separated from and seated on the annular valve seat 13d.

A coil spring 15 is interposed between the base portion 40a and the stepped portion forming the annular valve seat 13d of the piston connecting member 13, and the needle 40 is biased in a direction away from the annular valve seat 13d.

Therefore, when the adjustment rod 41 is pressed against a spring force of the coil spring 15, the valve head 40c approaches the annular valve seat 13d. Conversely, when the adjustment rod 41 is moved upward, the needle 40 is pushed up by the coil spring 15, and the valve head 40c is separated from the annular valve seat 13d. As described above, when the adjustment rod 41 is moved up and down in FIG. 2, the valve head 40c comes close to and away from the annular valve seat 13d, so that the flow path area (valve opening degree) formed between the needle 40 and the annular valve seat 13d can be adjusted. The damping force variable valve 4 provided in the bypass passage B is not limited to a needle valve, and may be any valve capable of changing the flow path area or the valve opening pressure in the bypass passage B.

In the front fork F configured as described above, when the fork main body 1 extends, the damper cartridge D also extends, and the extension side chamber R1 is compressed by the piston 10. Furthermore, when an extension speed of the fork main body 1 is low and the pressure of the extension side chamber R1 does not reach a pressure for opening the extension side leaf valve 11, in a state where the damping force variable valve 4 is opened, the liquid in the extension side chamber R1 moves to the compression side chamber R2 through the bypass passage B. The damping force variable valve 4 gives resistance to the flow of this liquid, so that a difference is produced between pressures of the extension side chamber R1 and the compression side chamber R2, and the front fork F exerts a damping force for suppressing the extension operation.

Furthermore, when the extension speed of the fork main body 1 becomes high, and the pressure of the extension side chamber R1 reaches a pressure for opening the extension side leaf valve 11, in a state where the damping force variable valve 4 is opened, the liquid in the extension side chamber R1 moves to the compression side chamber R2 through not only the bypass passage B but also the extension side port 10a. The damping force variable valve 4 and the extension side leaf valve 11 give resistance to the flow of this liquid, so that a difference is produced between the pressures of the extension side chamber R1 and the compression side chamber R2, and the front fork F exerts a damping force for suppressing the extension operation.

Furthermore, when the fork main body 1 contracts, the damper cartridge D also contracts, and the compression side chamber R2 is compressed by the piston 10. Furthermore, when a contraction speed of the fork main body 1 is low and the pressure of the compression side chamber R2 does not reach a valve opening pressure of the compression side leaf valve 12, in a state where the damping force variable valve 4 is opened, the liquid in the compression side chamber R2 moves to the extension side chamber R1 through the bypass passage B. The damping force variable valve 4 gives resistance to the flow of this liquid, so that a difference is produced between pressures of the extension side chamber R1 and the compression side chamber R2, and the front fork F exerts a damping force for suppressing the contraction operation. Furthermore, when the contraction speed of the fork main body 1 becomes high and the pressure of the compression side chamber R2 reaches a valve opening pressure of the compression side leaf valve 12, in a state where the damping force variable valve 4 is opened, the liquid in the compression side chamber R2 moves to the extension side chamber R1 through not only the bypass passage B but also the compression side port 10b.

The damping force variable valve 4 and the compression side leaf valve 12 give resistance to the flow of this liquid, so that a difference is produced between the pressures of the extension side chamber R1 and the compression side chamber R2, and the front fork F exerts a damping force for suppressing the contraction operation.

Here, since the damping force variable valve 4 of the present embodiment can adjust the valve opening degree of the needle 40 by moving the adjustment rod 41 in the axial direction to move the needle 40 up and down, a damping force characteristic (characteristic of the damping force with respect to the expansion/contraction speed) in both the expansion and contraction of the front fork F can be adjusted. Therefore, in the present embodiment, the damping force variable valve 4 and the adjustment rod 41 configure an adjusted portion accommodated in the fork main body 1.

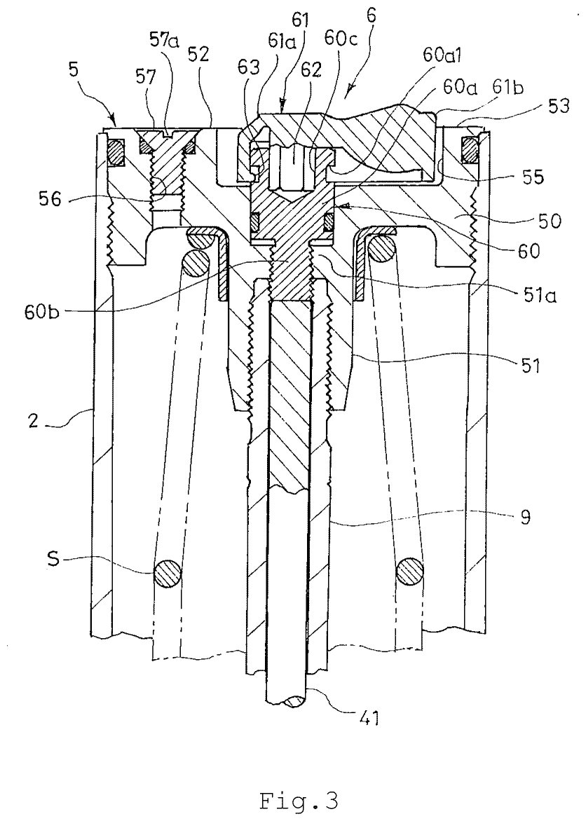

Next, the cap 5, and the adjuster 6 capable of adjusting the damping force characteristic of the damping force variable valve 4 mounted to the cap 5 will be described in detail. As illustrated in FIG. 3, the cap 5 of the present embodiment includes an annular cap main body 50 whose outer periphery is screwed to the inner periphery of the upper end of the vehicle body side tube 2 to close the upper end portion of the vehicle body side tube 2, and a connecting cylindrical portion 51 that is cylindrical, has an outer diameter smaller than that of the cap main body 50, and extends downward from the inner periphery of the lower end of the cap main body 50, and the outer periphery of the upper end of the piston rod 9 is screwed to the inner periphery of the connecting cylindrical portion 51. An annular flange portion 51a protruding inward is provided on the inner periphery of the upper end of the connecting cylindrical portion 51, and a screw groove is formed on the inner periphery of the flange portion 51a.

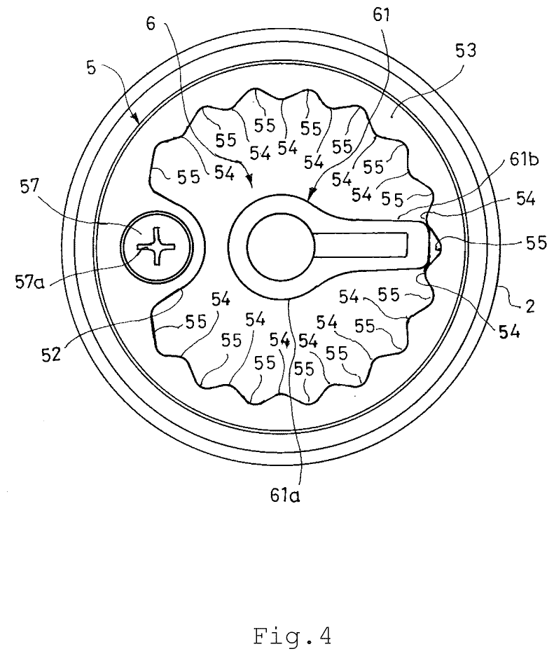

As illustrated in FIGS. 3 and 4, the adjuster 6 includes an adjuster main body 60 mounted to the cap main body 50 so as to be capable of rotating in the circumferential direction, and a lever 61 attached to the upper end of the adjuster main body 60 and extending in the radial direction from the upper end of the adjuster main body 60.

Specifically, as illustrated in FIGS. 3, 4, and 5, the adjuster main body 60 of the present embodiment includes a base portion 60a that has a columnar shape, is circumferentially rotatable in the inner periphery of the cap main body 50, and is inserted so as to be movable in the axial direction, and a screw shaft 60b that has an outer diameter smaller than the base portion 60a, extends from the lower end of the base portion 60a, has an outer periphery screwed onto the inner periphery of the flange portion 51a of the cap main body 50, and has a lower end abutting on the upper end of the adjustment rod 41. Therefore, when the adjuster main body 60 is rotated in the circumferential direction, the adjuster main body 60 moves in an up and down direction in the drawing, which is the axial direction, in a manner of a feed screw.

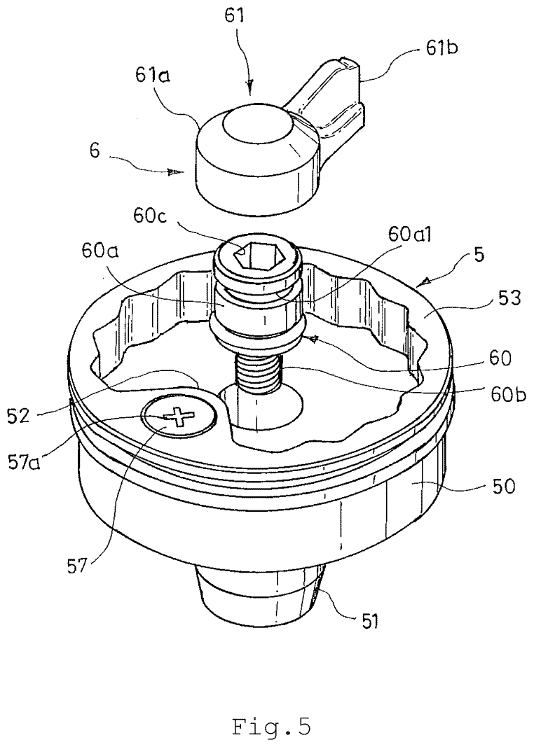

Since an axial length of the base portion 60a is longer than a distance from the upper end of the flange portion 51a of the cap main body 50 to the upper end of the cap main body 50, the upper end of the base portion 60a protrudes upward from the cap main body 50. Therefore, the base portion 60a includes an exposed portion that is constantly exposed to the outside from the cap main body 50 at the upper end. As illustrated in FIGS. 3 and 5, an annular groove 60a1 is formed on the outer periphery of the exposed portion of the base portion 60a. Further, the base portion 60a is formed with a hexagonal fitting hole 60c that opens from the upper end and extends along the axial direction.

Next, as illustrated in FIGS. 3, 4, and 5, the lever 61 of the present embodiment is made of a synthetic resin, and includes a mounting portion 61a having a cylindrical shape with a top mounted to the base portion 60a of the adjuster main body 60, and a lever main body 61b extending in the radial direction continuously with the outer periphery of the mounting portion 61a.

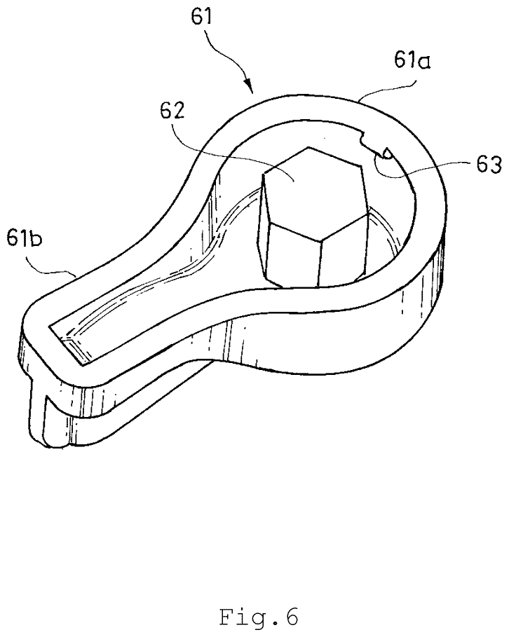

As illustrated in FIGS. 3 and 6, the lever 61 includes a hexagonal column-shaped fitting portion 62 protruding downward from the lower end of the top portion of the mounting portion 61a. The fitting portion 62 has a shape corresponding to the inner peripheral shape of the fitting hole 60c formed in the base portion 60a. Therefore, as illustrated in FIG. 3, when the fitting portion 62 is fitted into the fitting hole 60c and the mounting portion 61a is mounted to the base portion 60a, the lever 61 is attached in a state of being prevented from rotating with respect to the adjuster main body 60.

In the present embodiment, the fitting portion 62 is provided in the mounting portion 61a of the lever 61, and the fitting hole 60c is provided in the base portion 60a of the adjuster main body 60. However, a fitting portion may be provided in the base portion 60a, and a fitting hole may be provided in the mounting portion 61a of the lever 61. In this case, for example, when a cross-sectional shape of the outer periphery of the exposed portion of the base portion 60a and a cross-sectional shape of the inner periphery of the mounting portion 61a of the lever 61 are shapes other than perfect circles that coincide with each other, the inner periphery of the mounting portion 61a of the lever 61 can be used as the fitting hole with the base portion 60a as the fitting portion, and thus, processing for providing the fitting portion and the fitting hole is minimized. In the present embodiment, each of the fitting portion 62 and the fitting hole 60c is formed in a hexagonal shape, but the shape is not particularly limited as long as it is a shape other than a perfect circle as long as the rotation stop is possible.

In the present embodiment, the fitting portion 62 provided in the lever 61 is fitted into the fitting hole 60c provided in the adjuster main body 60 to prevent the lever 61 from rotating with respect to the adjuster main body 60. However, the means for preventing the lever 61 from rotating with respect to the adjuster main body 60 is not limited to the above means.

An inner diameter of the mounting portion 61a is set to be substantially the same as an outer diameter of the base portion 60a, and a claw 63 protruding inward is provided on the inner periphery of the lower end of the cylindrical portion of the mounting portion 61a. Then, as illustrated in FIG. 3, in a state where the mounting portion 61a is mounted to the base portion 60a, the claw 63 enters and is caught in the annular groove 60al provided on the outer periphery of the base portion 60a, so that the mounting portion 61a can be prevented from coming off the base portion 60a.

Note that the installation position of the claw 63 in the circumferential direction of the mounting portion 61a is not particularly limited. However, as illustrated in FIG. 6, when the claw 63 is provided at a position radially facing the lever main body 61b on the inner periphery of the lower end of the cylindrical portion of the mounting portion 61a, even when a force in a direction of lifting the lever 61 acts on the mounting portion 61a from only the lever main body 61b side when the user grips the lever main body 61b and operates the lever 61, the claw 63 is deeply caught in the annular groove 60al, so that the mounting portion 61a can be reliably prevented from coming off the base portion 60a during the operation of the lever 61. The number of the claws 63 is not particularly limited, and a plurality of the claws 63 may be provided on the inner periphery of the lower end of the cylindrical portion of the mounting portion 61a. When the plurality of claws 63 are installed on the inner periphery of the lower end of the cylindrical portion of the mounting portion 61a in this manner, the mounting portion 61a of the lever 61 can be more reliably prevented from coming off the base portion 60a.

In addition, when the mounting portion 61a of such a lever 61 is mounted to the base portion 60a, since the lever 61 is made of synthetic resin and can be elastically deformed, when the claw 63 abuts on the outer periphery of the base portion 60a, the inner diameter of the mounting portion 61a increases, and the base portion 60a can be inserted into the mounting portion 61a. Then, when the base portion 60a is inserted into the mounting portion 61a until the claw 63 faces the annular groove 60al of the base portion 60a, the mounting portion 61a returns to the original shape, so that the claw 63 enters the annular groove 60al and the lever 61 is attached in a state of being prevented from coming off with respect to the adjuster main body 60.

In the present embodiment, the claw 63 provided on the lever 61 is hooked on the annular groove 60al provided on the outer periphery of the base portion 60a of the adjuster main body 60 to prevent the lever 61 from coming off the adjuster main body 60. However, the means for preventing the lever 61 from coming off with respect to the adjuster main body 60 is not limited to the above means.

As described above, in the present embodiment, the lever 61 is attached to the adjuster main body 60 in a state of being prevented from rotating and coming off. Therefore, when the user grips the lever main body 61b of the lever 61 and rotates the lever 61, the adjuster main body 60 rotates in the circumferential direction together with the lever 61, so that the adjuster main body 60 moves in the up and down direction as the axial direction in a manner of a feed screw.

Here, as will be described in detail later, as illustrated in FIGS. 3 and 4, the cap main body 50 includes a stopper 52 that protrudes in the axial direction from the upper end of the cap main body 50 and restricts the rotation of the lever 61 when abutting on the lever 61.

Furthermore, in the present embodiment, even when the lever 61 is rotated until it abuts on the stopper 52 in the direction in which the adjuster main body 60 is screwed downward, a gap is formed between the lower end of the cylindrical portion of the mounting portion 61a of the lever 61 and the upper end of the cap main body 50.

Therefore, when the adjuster main body 60 is rotated and moved downward, the lower end of the cylindrical portion of the mounting portion 61a of the lever 61 does not abut on the upper end of the cap main body 50, so that the downward movement of the adjuster main body 60 is not prevented.

In the present embodiment, as illustrated in FIG. 3, a length of the claw 63 in the up and down direction is shorter than a vertical width of the annular groove 60a1. Therefore, the movement of the lever 61 in the up and down direction with respect to the adjuster main body 60 is allowed by the difference between the length of the claw 63 in the up and down direction and the vertical width of the annular groove 60a1.

Then, even when the gap formed between the lower end of the cylindrical portion of the mounting portion 61a of the lever 61 and the upper end of the cap main body 50 becomes smaller than the design due to an error at the time of assembly, and the lower end of the cylindrical portion of the mounting portion 61a abuts on the upper end of the cap main body 50 when the adjuster main body 60 is moved downward, the lever 61 can be moved upward with respect to the adjuster main body 60 by the difference between the length of the claw 63 in the up and down direction and the vertical width of the annular groove 60a1. Therefore, even in such a case, the downward movement of the adjuster main body 60 is not prevented. However, the length of the claw 63 in the up and down direction and the vertical width of the annular groove 60al may be set to the same size.

Since the lower end of the screw shaft 60b of the adjuster main body 60 abuts on the upper end of the adjustment rod 41, when the adjuster main body 60 is moved up and down in the axial direction as described above, the adjustment rod 41 moves up and down in the axial direction, and the valve opening degree of the needle 40 can be adjusted, so that the damping force characteristic of the damping force variable valve 4 can be adjusted.

The configuration of the adjuster 6 described above is an example, and the configuration of the adjuster 6 is not particularly limited as long as the damping force characteristic of the damping force variable valve 4 can be adjusted. For example, a screw cylindrical portion provided with a screw groove on the inner periphery may be provided at the upper end of the adjustment rod 41 while the adjustment rod 41 is prevented from rotating with respect to the piston rod 9, and the screw cylindrical portion may be screwed onto the outer periphery of the screw shaft 60b of the adjuster main body 60. In this way, when the adjuster 6 is rotated in the circumferential direction, the adjustment rod 41 moves in the axial direction on the screw shaft 60b in a manner of a feed screw, so that the valve opening degree of the needle 40 can be adjusted.

The method of attaching the lever 61 to the adjuster main body 60 is not particularly limited as long as the lever 61 is prevented from rotating or coming off with respect to the adjuster main body 60. For example, the lever 61 may be attached to the adjuster main body 60 by screwing or bonding. However, according to the attaching method of the present embodiment, it is only necessary to cover and mount the lever 61 to the base portion 60a of the adjuster main body 60, so that the adjuster 6 can be easily assembled. In the present embodiment, the lever 61 is made of synthetic resin, but the material of the lever 61 is not particularly limited, and may be made of metal, for example.

As illustrated in FIGS. 3 and 4, the cap main body 50 is provided with the stopper 52 that protrudes in the axial direction from the upper end of the cap main body 50 and restricts the rotation of the lever 61 when abutting on the lever 61.

Specifically, as illustrated in FIG. 4, the stopper 52 protrudes in the axial direction from a partial position on the rotation track of the lever main body 61b when the lever 61 at the upper end of the cap main body 50 is rotated in the circumferential direction. Therefore, when the lever main body 61b abuts on one end or the other end of the side portion of the stopper 52 during the rotational operation of the lever 61, further rotation of the lever 61 is restricted. That is, the rotatable range of the lever 61 is a circumferential range from one end to the other end of the side portion of the stopper 52.

In the present embodiment, when the lever 61 is rotated clockwise in FIG. 4 so as to abut on one end of the side portion of the stopper 52, the adjuster main body 60 moves downward by a maximum amount, so that the adjustment rod 41 also moves downward by a maximum amount, and the valve opening degree of the needle 40 can be minimized. Conversely, when the lever 61 is rotated counterclockwise in FIG. 4 so as to abut on the other end of the side portion of the stopper 52, the adjuster main body 60 moves upward by a maximum amount, so that the adjustment rod 41 also moves upward by a maximum amount, and the valve opening degree of the needle 40 can be maximized.

Note that a relationship between a rotation direction of the lever 61 and the valve opening degree of the needle 40 described above is an example, and the valve opening degree of the needle 40 may be increased when the lever 61 is rotated counterclockwise in FIG. 4, and the valve opening degree of the needle 40 may be decreased when the lever 61 is rotated clockwise in FIG. 4.

In addition, when such a stopper 52 is provided, the rotatable range of the lever 61 becomes less than one rotation. In the present embodiment, the screw shaft 60b of the adjuster main body 60 is screwed into the flange portion 51a of the cap main body 50 by being screwed at least one rotation or more until being disposed at a predetermined position. Therefore, since the adjuster main body 60 can be only rotated in a disengagement direction (counterclockwise in FIG. 4) by less than one rotation, the adjuster 6 can be prevented from falling off the cap 5 by the rotational operation of the lever 61 by the user.

In the present embodiment, the cap 5 includes the annular protruding portion 53 that stands upright from the upper end of the cap main body 50 and rotatably accommodates the lever 61 inside, and on the inner periphery of the annular protruding portion 53, convex portions 54 capable of abutting on a distal end of the lever main body 61b of the lever 61 and concave portions 55 having a depth not abutting on the distal end of the lever main body 61b of the lever 61 are alternately provided in the circumferential direction.

Specifically, as illustrated in FIGS. 3 and 4, the annular protruding portion 53 is formed in a C shape standing along the outer periphery of the upper end of the cap main body 50 and having one end and the other end connected to the stopper 52 respectively.

The convex portion 54 is formed to protrude inward in the radial direction from the inner periphery of the annular protruding portion 53, and the center of an inscribed circle passing through the distal end of each convex portion 54 coincides with the rotation center of the lever 61. A diameter of the inscribed circle is set to be slightly smaller than a diameter of a virtual circle through which the distal end of the lever main body 61b passes when the lever 61 is rotated in the circumferential direction.

Therefore, as illustrated in FIG. 4, in a state where the distal end of the lever main body 61b of the lever 61 is fitted into the concave portion 55, the distal end of the lever main body 61b is sandwiched between two convex portions 54 and 54, so that the rotational position of the lever 61 can be positioned according to the number of concave portions 55.

Furthermore, in a state where the distal end of the lever main body 61b is fitted into the concave portion 55, the user cannot rotate the lever 61 unless the user rotates the lever 61 with a force of a predetermined torque or more with which the distal end of the lever main body 61b can get over the convex portion 54. Therefore, at the moment when the distal end of the lever main body 61b of the lever 61 is fitted into the concave portion 55, vibration is given to the user who rotates the lever 61, and when the lever 61 tries to get over the convex portion 54, resistance to suppress the rotational operation of the lever 61 is given to the user, so that these are perceived by the user as a click feeling.

Therefore, when the convex portion 54 and the concave portion 55 as described above are provided on the inner periphery of the annular protruding portion 53, a click feeling is given to the user when the lever 61 is rotated, and the user can perceive that the damping force characteristic of the damping force variable valve 4 is switched. However, the convex portion 54 and the concave portion 55 may be omitted as long as it is not necessary to make the user perceive a click feeling at the time of the rotational operation of the lever 61.

In the present embodiment, since the lever 61 is accommodated inside the annular protruding portion 53, the lever 61 is protected by the annular protruding portion 53, and it is possible to prevent sludge or the like from entering between the lever 61 and the cap main body 50 and hindering the rotation of the lever 61.

In addition, a height of the annular protruding portion 53 is not particularly limited, but when the height of the annular protruding portion 53 is increased, sludge or the like is less likely to enter the inside of the annular protruding portion 53 by that amount, so that the effect of preventing entry of sludge or the like between the lever 61 and the cap main body 50 is improved. In the present embodiment, the annular protruding portion 53 and the stopper 52 have the same height, but the annular protruding portion 53 and the stopper 52 may have different heights. The annular protruding portion 53 and the stopper 52 may be provided separately at the upper end of the cap main body 50.

The annular protruding portion 53 may be omitted when there is no concern that the sludge reaches the vicinity of the lever 61 while the straddle vehicle is traveling.

As illustrated in FIGS. 3 and 4, the cap 5 of the present embodiment includes an air hole 56 that is opened from the upper end of the stopper 52, penetrates the cap main body 50, and communicates with the inside of the fork main body 1, and an air valve 57 accommodated in the air hole 56.

The air valve 57 of the present embodiment is a valve that is screwed to the inner periphery of the air hole 56 to close the air hole 56. A groove 57a that allows insertion of a distal end of a driver is provided at the upper end of the air valve 57, and the air valve 57 can be rotated with respect to the cap main body 50 using the driver.

Here, when the front fork F repeatedly expands and contracts, air is dissolved from the hydraulic oil stored in the fork main body 1, and an air pressure in the fork main body 1 increases. In such a case, the air valve 57 is loosened to cause the inside and outside of the fork main body 1 to communicate with each other via the air hole 56, so that the air pressure in the fork main body 1 can be returned to the atmospheric pressure.

The air valve 57 is accommodated in the air hole 56 that opens from the upper end of the stopper 52 and penetrates the cap main body 50. Therefore, an axial position of the air valve 57 is positioned upward by the protruding height of the stopper 52 as compared with a case where the air hole 56 for accommodating the air valve 57 is provided only in the cap main body 50, so that the volume of the inside of the fork main body 1 can be secured by that amount.

Furthermore, in the present embodiment, since the air valve 57 is accommodated in the air hole 56 penetrating the stopper 52 and the cap main body 50 in the cap 5, the cap main body 50 does not need to have a wall thickness capable of accommodating the air valve 57. Therefore, since a thickness of the cap main body 50 can be reduced, a weight of the cap 5 can be reduced.

Note that the air valve 57 of the present embodiment is an air removal valve for returning the air pressure in the fork main body 1 to the atmospheric pressure. However, in a case where a gas having a pressure equal to or higher than the atmospheric pressure is enclosed in the reservoir R of the fork main body 1 and the gas is caused to function as an air spring that biases the fork main body 1 in the extending direction instead of the suspension spring S, the air valve 57 may be capable of supplying and discharging the gas into and from the reservoir R. In this case, the spring characteristic of the air spring can be adjusted by supplying and discharging the gas via the air valve 57.

As described above, the front fork F of the present embodiment includes the fork main body 1 in which the vehicle body side tube 2 and the axle side tube 3 are slidably fitted, the adjustment rod 41 and the damping force variable valve 4 as the adjusted portions accommodated in the fork main body 1, the cap 5 that closes the upper end portion of the vehicle body side tube 2, and the adjuster 6 mounted to the cap 5 and capable of adjusting the damping force characteristic of the damping force variable valve 4. The adjuster 6 includes the adjuster main body 60 mounted to the cap 5 so as to be capable of rotating in the circumferential direction by being screwed into the cap 5, and the lever 61 provided at the upper end of the adjuster main body 60 and extending in the radial direction from the upper end of the adjuster main body 60. The cap 5 includes the cap main body 50 that closes the upper end portion of the vehicle body side tube 2, the stopper 52 that protrudes in the axial direction from the upper end of the cap main body 50 and restricts rotation of the lever 61 when abutting on the lever 61, the air hole 56 that opens from the upper end of the stopper 52 and communicates with the inside of the fork main body 1, and the air valve 57 accommodated in the air hole 56.

According to this configuration, in a state where the adjuster main body 60 is mounted to the cap 5 by screwing, a rotatable range of the lever 61 becomes less than one rotation by the stopper 52. Therefore, when the adjuster main body 60 is screwed into the cap 5 by being screwed at least one rotation or more, the adjuster 6 can be prevented from falling off the cap 5 by the rotational operation of the lever 61 by the user.

Therefore, in the front fork F of the present embodiment, unlike the conventional front fork, it is not necessary to perform processing of press-fitting the adjuster case from above the adjuster mounted to the cap, or providing an annular groove for fitting the snap ring to the inner periphery of the through hole provided in the cap. Therefore, an assembly cost and a processing cost of the front fork F can be reduced.

According to this configuration, the air valve 57 is accommodated in the air hole 56 that opens from the upper end of the stopper 52 and penetrates the cap main body 50. Therefore, an axial position of the air valve 57 is positioned upward by the protruding height of the stopper 52 as compared with a case where the air hole 56 for accommodating the air valve 57 is provided only in the cap main body 50, so that the volume of the inside of the fork main body 1 can be secured by that amount.

Furthermore, since the air valve 57 is accommodated in the air hole 56 penetrating the stopper 52 and the cap main body 50 in the cap 5, the cap main body 50 does not need to have a wall thickness capable of accommodating the air valve 57. Therefore, since a thickness of the cap main body 50 can be reduced, a weight of the cap 5 can be reduced.

Further, in the front fork F of the present embodiment, the adjuster main body 60 is screwed into the cap 5 by being screwed one rotation or more, the lever 61 is rotatable in the circumferential direction, and the stopper 52 protrudes in the axial direction from a partial position on the rotation track of the lever 61 at the upper end of the cap main body 50.

According to this configuration, since the rotatable range of the lever 61 is the circumferential range from one end to the other end of the side portion of the stopper 52, the rotatable range of the lever 61 becomes less than one rotation. In addition, since the adjuster main body 60 is screwed into the cap 5 by being screwed one rotation or more, the adjuster 6 can be prevented from falling off the cap 5 by the rotational operation of the lever 61 by the user.

In the present embodiment, the adjuster main body 60 is screwed onto the inner periphery of the flange portion 51a of the connecting cylindrical portion 51 in the cap 5, but the adjuster main body 60 may be screwed to the adjustment rod 41 configuring the adjusted portion. Specifically, for example, a screw cylindrical portion provided with a screw groove on the inner periphery may be provided at the upper end of the adjustment rod 41 while the adjustment rod 41 is prevented from rotating with respect to the piston rod 9, and the screw cylindrical portion may be screwed onto the outer periphery of the screw shaft 60b of the adjuster main body 60. In this way, when the adjuster 6 is rotated in the circumferential direction, the adjustment rod 41 moves in the axial direction on the screw shaft 60b in a manner of a feed screw, so that the valve opening degree of the needle 40 is adjusted, and the damping force characteristic of the damping force variable valve 4 can be adjusted.

In the present embodiment, the adjustment rod 41 and the damping force variable valve 4 that exert a damping force when the front fork F expands and contracts are the adjusted portions. However, the adjusted portion is not limited to the adjustment rod 41 and the damping force variable valve 4. For example, the adjusted portion may be a pair of spring seats that support the suspension spring S and the end portion of the suspension spring S, and the axial position of the spring seat that supports the upper end of the suspension spring S may be adjusted by the adjuster 6 to adjust an initial load of the suspension spring S.

In the front fork F of the present embodiment, the cap 5 has an annular protruding portion 53 that rotatably accommodates the lever 61 inside. According to this configuration, since the lever 61 is accommodated and protected inside the annular protruding portion 53, it is possible to prevent sludge or the like from entering between the lever 61 and the cap main body 50 and hindering the rotation of the lever 61. However, the annular protruding portion 53 may be omitted when the sludge does not reach the vicinity of the lever 61 while the straddle vehicle is traveling or the lever 61 does not need to be protected.

In addition, in the front fork F of the present embodiment, a plurality of convex portions 54 capable of abutting on the distal end of the lever 61 and a plurality of concave portions 55 having a depth not abutting on the distal end of the lever 61 are alternately provided on the inner periphery of the annular protruding portion 53 in the circumferential direction, and when the lever 61 is rotated by a force of a predetermined torque or more, the lever 61 gets over the convex portions 54 and rotates.

According to this configuration, at the moment when the lever main body 61b, which is the distal end of the lever 61, is fitted into the concave portion 55 when the lever 61 is rotationally operated, vibration is given to the user who rotates the lever 61, and when the lever 61 is about to get over the convex portion 54, resistance to suppress the rotational operation of the lever 61 is given to the user, so that these are perceived by the user as a click feeling. Therefore, when the lever 61 is rotated, a click feeling is given to the user, and the user can perceive that the damping force characteristic of the damping force variable valve 4 as the adjusted portion is adjusted.

In the conventional front fork, a detent mechanism is provided between the adjuster and the adjuster case in order to give a click feeling to the user when the adjuster is rotated. This detent mechanism includes a polygonal inner peripheral portion provided on the inner periphery of the adjuster case, a bag hole opened to the adjuster from a side and facing the polygonal inner peripheral portion, and a ball accommodated in the bag hole and biased toward the polygonal inner peripheral portion side by a coil spring. When the adjuster is rotated, the ball is fitted to any of corners of the polygonal inner peripheral portion to make a user perceive a click feeling. The detent mechanism has a complicated structure.

On the other hand, in the present embodiment, a plurality of convex portions 54 that can abut on the distal end of the lever 61 and a plurality of concave portions 55 having a depth that does not abut on the distal end of the lever 61 are alternately provided on the inner periphery of the annular protruding portion 53 in the circumferential direction, so that the structure is simple. Therefore, the front fork F can be easily processed and assembled, and the cost can be reduced. However, the convex portion 54 and the concave portion 55 may be omitted.

Further, in the present embodiment, the fitting portion 62 provided in the lever 61 and the fitting hole 60c provided in the base portion 60a of the adjuster main body 60 have hexagonal shapes to be fitted to each other. Therefore, when the lever 61 is attached to the adjuster main body 60, the initial position of the lever 61 in the circumferential direction is determined depending on which corner of the fitting portion 62 is fitted to which corner of the fitting hole 60c.

Here, since the rotatable range of the lever 61 is a range from one end to the other end of the side portion of the stopper 52 as described above, the adjustable range of the damping force characteristic of the damping force variable valve 4 is automatically determined by the initial position of the lever 61.

Therefore, in the present embodiment, the adjustable range of the damping force characteristic of the damping force variable valve 4 can be arbitrarily set by arbitrarily selecting which corner of the fitting portion 62 is fitted to which corner of the fitting hole 60c.

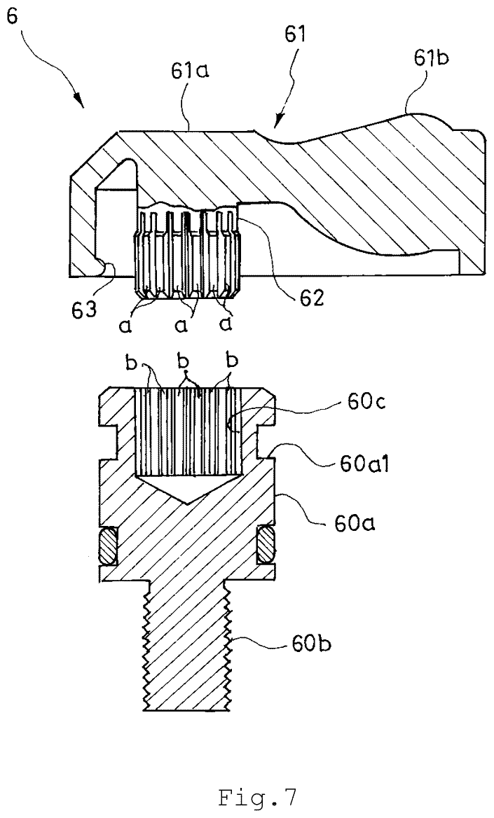

However, instead of forming the fitting portion 62 provided in the lever 61 and the fitting hole 60c provided in the base portion 60a of the adjuster main body 60 into hexagonal shapes to be fitted to each other, as illustrated in FIG. 7, a plurality of spline grooves a arranged in the circumferential direction may be provided on the inner periphery of the fitting hole 60c, and a plurality of spline teeth b to be meshed with the spline grooves a may be provided on the outer periphery of the fitting portion 62.

According to this configuration, since the spline grooves a and the spline teeth b are continuous in the circumferential direction respectively, a degree of freedom in selecting the initial position of the lever 61 becomes very high when the lever 61 is attached to the adjuster main body 60 by meshing the spline grooves a and the spline teeth b. Therefore, a degree of freedom in setting the adjustable range of the damping force variable valve 4 becomes very high.

In the present embodiment, the fitting portion 62 is provided in the mounting portion 61a of the lever 61, and the fitting hole 60c is provided in the base portion 60a of the adjuster main body 60. However, a fitting portion may be provided in the base portion 60a, and a fitting hole may be provided in the mounting portion 61a of the lever 61.

In the embodiment illustrated in FIG. 7, a plurality of spline grooves a are provided on the inner periphery of the fitting hole 60c, and a plurality of spline teeth b are provided on the outer periphery of the fitting portion 62. However, the plurality of spline teeth b may be provided on the inner periphery of the fitting hole 60c, and the plurality of spline grooves a may be provided on the outer periphery of the fitting portion 62. In addition, serration grooves and serration teeth may be provided instead of the spline grooves a and the spline teeth b.

Although the preferred embodiment of the present invention has been described in detail above, modifications, variations, and alterations can be made without departing from the scope of the claims.

### REFERENCE SIGNS LIST

1 Fork main body
2 Vehicle body side tube
3 Axle side tube
4 Damping force variable valve (adjusted portion)
5 Cap
6 Adjuster
41 Adjustment rod (adjusted portion)
60 Adjuster main body
61 Lever
50 Cap main body
52 Stopper
53 Annular protruding portion
54 Convex portion
55 Concave portion
56 Air hole
57 Air valve
60c Fitting hole
62 Fitting portion
a Spline groove
b Spline tooth
F Front fork

1. A front fork comprising:
a fork main body in which a vehicle body side tube and an axle side tube are slidably fitted;
an adjusted portion accommodated in the fork main body;
a cap that closes an upper end portion of the vehicle body side tube; and
an adjuster that is mounted to the cap and is capable of adjusting the adjusted portion, wherein
the adjuster includes an adjuster main body that is mounted to the cap so as to be capable of rotating in a circumferential direction by being screwed into the cap or the adjusted portion, and a lever that is provided at an upper end of the adjuster main body and extends in a radial direction from the upper end of the adjuster main body, and
the cap includes a cap main body that closes the upper end portion of the vehicle body side tube, a stopper that protrudes in an axial direction from an upper end of the cap main body and restricts rotation of the lever when abutting on the lever, an air hole that opens from an upper end of the stopper and communicates with an inside of the fork main body, and an air valve accommodated in the air hole.

2. The front fork according to claim 1, wherein
the adjuster main body is screwed into the cap or the adjusted portion by being screwed one rotation or more,
the lever is rotatable in the circumferential direction, and
the stopper protrudes in the axial direction from a partial position on a rotation track of the lever at the upper end of the cap main body.

3. The front fork according to claim 1, wherein
the cap has an annular protruding portion that rotatably accommodates the lever inside.

4. The front fork according to claim 3, wherein
a plurality of convex portions capable of abutting on a distal end of the lever and a plurality of concave portions having a depth not abutting on the distal end of the lever are alternately provided on an inner periphery of the annular protruding portion in the circumferential direction, and
when the lever is rotationally operated with a force of a predetermined torque or more, the lever gets over the convex portion and rotates.

5. The front fork according to claim 1, wherein
a fitting hole along the axial direction is formed in one of an upper end of the adjuster and the lever,
a fitting portion to be fitted to the fitting hole is provided in the other of the upper end of the adjuster and the lever,
a plurality of spline grooves or serration grooves arranged in the circumferential direction are provided on one of an inner periphery of the fitting hole and an outer periphery of the fitting portion, and
a plurality of spline teeth or serration teeth to be meshed with the spline grooves or the serration grooves are provided on the other of the inner periphery of the fitting hole and the outer periphery of the fitting portion.
